(19) United States
(12) Patent Application Publication
(10) Pub. No.: US 2026/0202726 A1
(43) Pub. Date: Jul. 16, 2026

(54) ILLUMINATION SYSTEM AND PROJECTION DEVICE

(71) Applicant: Coretronic Corporation, Hsin-Chu (TW)

(72) Inventors: Yu-Hsiang DENG, Hsin-Chu (TW); Jui CHANG, Hsin-Chu (TW)

(21) Appl. No.: 19/443,047

(22) Filed: Jan. 8, 2026

(30) Foreign Application Priority Data
Jan. 13, 2025 (CN) 2025100499198

(51) Int. Cl. G03B 21/20

(52) U.S. Cl. CPC G03B 21/204; G03B 21/2013; G03B 21/206; G03B 21/2066; G03B 21/208

(57) ABSTRACT

An illumination system includes a light source device, a light spot shaping component, a wavelength conversion component, a first light homogenizing component, a light combining component and a second light homogenizing component. The light source device is configured to emit a first color beam and a second color beam. The light spot shaping component shapes the first color beam to form a first color shaping beam, and the first color shaping beam is directly or indirectly transmitted to the light combining component. The wavelength conversion component converts the first color shaping beam into excited light which is transmitted to the light combining component. The second color beam passes through the first light homogenizing component and is incident on the light combining component. The second light homogenizing component guides the excited light, the first color shaping beam and the second color beam to the second light homogenizing component.

### CROSS REFERENCE TO RELATED APPLICATION

This application claims the priority benefit of Chinese Patent Application Serial Number 2025100499198, filed on 13th, January, 2025, the full disclosure of which is incorporated herein by reference.

### BACKGROUND

### Technical Field

The present disclosure is related to the technical field of optical projection and is particularly related to an illumination system and a projection device.

### Related Art

As solid-state light sources and projection technologies develop, projectors are common in people’s daily lives. As the display requirements of the projectors daily rise, laser projectors are generated accordingly and has numerous advantages such as a long lifespan and high color saturation.

The current laser projector includes an illumination system and a projection lens, and the light source device of a combiner in the illumination system may be a pure laser device exemplarily including a red laser component, a blue laser component, and a green laser component. The light source device of the laser projector in another embodiment may be further provided with a component with phosphor, and a blue laser beam emitted by the blue laser component is usually configured to excite the phosphor to generate excited light. However, the etendue of the laser beam is low, while the etendue of the excited light is high, and the mismatch between the etendue of the laser beam and the etendue of the excited light is caused, thereby reducing the contrast ratio and the color uniformity of the laser projector.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In light of the aforementioned description, the present disclosure provides an illumination system and a projection device to solve the problem of the mismatch between the etendue of the laser beam and the etendue of the excited light.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

In order to achieve one, one part or all of the objectives, the illumination system in one embodiment of the present disclosure is adapted to provide an illumination light beam and includes a light source device, a light spot shaping component, a wavelength conversion component, a first light homogenizing component, a light combining component, and a second light homogenizing component. The light source device is configured to emit a first color beam and a second color beam. The light spot shaping component is disposed on the travelling path of the first color beam and shapes the first color beam to form a first color shaping beam. The wavelength conversion component is disposed on the travelling path of the first color shaping beam and is configured to convert the first color shaping beam into excited light. The excited light and the first color shaping beam leave from the wavelength conversion component at different timing. The first light homogenizing component is disposed on the travelling path of the second color beam. The light combining component is disposed on the travelling path of the excited light, the travelling path of the first color shaping beam and the travelling path of the second color beam, and guides at least one part of the excited light, the first color shaping beam and the second color beam to the second light homogenizing component. The illumination beam includes at least one of at least one part of the excited light, the first color shaping beam and the second color beam.

In one embodiment of the present disclosure, the light combining component is disposed between the first light homogenizing component and the second light homogenizing component.

In one embodiment of the present disclosure, the first color shaping beam from the wavelength conversion component passes through the first light homogenizing component and is incident on the light combining component; the first light homogenizing component is not arranged on the travelling path of the excited light from the wavelength conversion component.

In one embodiment of the present disclosure, the first color shaping beam is directly incident on the light combining component; the first light homogenizing component is not arranged on the travelling path of the first color shaping beam from the wavelength conversion component and the travelling path of the excited light from the wavelength conversion component.

In one embodiment of the present disclosure, the wavelength conversion component includes a wavelength-converting region and a non-wavelength-converting region which are disposed on a substrate. The substrate is adapted to rotate around a rotation axis, and the wavelength-converting region and the non-wavelength-converting region enter the travelling path of the first color shaping beam at different timing. The wavelength-converting region is configured to convert the first color shaping beam into the excited light, while the non-wavelength-converting region is configured to reflect the first color shaping beam or allow the first color shaping beam to pass through.

In one embodiment of the present disclosure, the light spot shaping component includes a transparent substrate and a plurality of shaped microstructures disposed on the transparent substrate, the first light homogenizing component includes a first substrate and a plurality of first microstructures disposed on the first substrate, and the second light homogenizing component includes a second substrate and a plurality of second microstructures disposed on the second substrate.

In one embodiment of the present disclosure, the shape of orthogonal projection on the transparent substrate of one of the shaped microstructures is different from the shape of orthogonal projection on the first substrate of one of the first microstructures, and the shape of orthogonal projection on the first substrate of one of the first microstructures is different from the shape of orthogonal projection on the second substrate of one of the second microstructures.

In one embodiment of the present disclosure, each of the first microstructures has a first aspect ratio, each of the second microstructures has a second aspect ratio, and each of the shaped microstructures has a third aspect ratio. The third aspect ratio is different from the first aspect ratio but is similar to or approximates the second aspect ratio.

In one embodiment of the present disclosure, the first light homogenizing component is a fly-eye lens, and the first microstructures is a first microlens array. The second light homogenizing component is the fly-eye lens, and the second microstructures is a second microlens array.

In one embodiment of the present disclosure, the light source device includes a first color light-emitting unit and a second color light-emitting unit. The first color light-emitting unit is configured to provide the first color beam, and the second color light-emitting unit is configured to provide the second color beam; the first color beam is a blue laser beam, the second color beam is a green laser beam or a red laser beam. The wavelength range of the excited light at least partially overlaps the wavelength range of the second color beam.

In one embodiment of the present disclosure, the light source device includes a first color light-emitting unit, a second color light-emitting unit, and a third color light-emitting unit. The first color light-emitting unit is configured to provide the first color beam, the second color light-emitting unit is configured to provide the second color beam, and the third color light-emitting unit is configured to provide a third color beam. The first color beam is the blue laser beam, the second color beam is the green laser beam, and the third color beam is the red laser beam. The wavelength range of the excited light at least partially overlaps the wavelength range of the green laser beam and the wavelength range of the red laser beam.

In one embodiment of the present disclosure, the first color light-emitting unit and the third color light-emitting unit are turned on and the second color light-emitting unit is turned off during red beam timing. The red laser beam passes through the first light homogenizing component and is incident on the light combining component, and the wavelength-converting region enters the travelling path of the first color shaping beam and converts the first color shaping beam into the excited light. The excited light is transmitted to the light combining component; the light combining component guides at least one part of the excited light and the red laser beam to the second light homogenizing component, and at least one part of the excited light and the red laser beam leaving from the second light homogenizing component serve as the illumination beam.

In one embodiment of the present disclosure, the third color light-emitting unit is turned off and the first color light-emitting unit and the second color light- emitting unit are turned on during green beam timing. The green laser beam passes through the first light homogenizing component and is incident on the light combining component, the wavelength-converting region enters the travelling path of the first color shaping beam and converts the first color shaping beam into the excited light. The excited light is transmitted to the light combining component; the light combining component guides at least one part of the excited light and the green laser beam to the second light homogenizing component, and at least one part of the excited light and the green laser beam leaving from the second light homogenizing component serve as the illumination beam.

In one embodiment of the present disclosure, the second color light-emitting unit and the third color light-emitting unit are turned off and the first color light-emitting unit is turned on during blue beam timing. The non-wavelength-converting region enters the travelling path of the first color shaping beam, and the first color shaping beam from the non-wavelength-converting region is incident on the light combining component after passing through the first light homogenizing component or is directly incident on the light combining component. The light combining component guides the first color shaping beam to the second light homogenizing component, and the first color shaping beam leaving from the second light homogenizing component serves as the illumination beam.

In one embodiment of the present disclosure, the first color light-emitting unit, the second color light-emitting unit, and the third color light-emitting unit are turned on during yellow beam timing. The red laser beam and the green laser beam pass through the first light homogenizing component and are incident on the light combining component, and the wavelength-converting region enters the travelling path of the first color shaping beam and converts the first color shaping beam into the excited light. The excited light is transmitted to the light combining component; the light combining component guides at least one part of the excited light, the red laser beam and the green laser beam to the second light homogenizing component, and at least one part of the excited light, the red laser beam and the green laser beam leaving from the second light homogenizing component serve as the illumination beam.

In one embodiment of the present disclosure, the illumination system further includes a dichroic mirror located between the light source device and the first light homogenizing component. The light spot shaping component is located between the dichroic mirror and the wavelength conversion component, and the dichroic mirror guides the second color beam to the first light homogenizing component and guides the first color beam to the light spot shaping component.

In one embodiment of the present disclosure, the illumination system further includes a polarization component disposed between the light source device and the first light homogenizing component. The polarization component is arranged on the travelling path of the red laser beam and is configured to change the polarization state of the red laser beam so that the polarization state of the red laser beam is the same as the polarization state of the blue laser beam and the polarization state of the green laser beam. Or the polarization component is arranged on the travelling path of the blue laser beam and the travelling path of the green laser beam and is configured to change the polarization states of the blue laser beam and the green laser beam so that the polarization states of the blue laser beam and the green laser beam are the same as the polarization state of the red laser beam.

In one embodiment of the present disclosure, the light spot shaping component is an anisotropic diffuser, a microlens array component or a cylindrical lens array component.

In order to achieve one, one part or all of the objectives, the projection device in one embodiment of the present disclosure includes the aforementioned illumination system, a light valve, and a projection lens. The light valve is disposed on the travelling path of the illumination beam and converts the illumination beam into an image beam. The projection lens is disposed on the travelling path of the image beam.

In one embodiment of the present disclosure, the light spot shaping component is provided with a plurality of shaped microstructures, the first light homogenizing component is provided with a plurality of first microstructures, the second light homogenizing component is provided with a plurality of second microstructures, and the light valve is provided with a plurality of micromirrors.

In one embodiment of the present disclosure, each of the first microstructures has a first aspect ratio, each of the second microstructures has a second aspect ratio, each of the shaped microstructures has a third aspect ratio, and each of the micromirrors has a micromirror aspect ratio. The third aspect ratio is different from the first aspect ratio but is similar to or approximates the second aspect ratio and the micromirror aspect ratio.

In view of the above description, the illumination system of the present disclosure facilitates the correspondence between the light spot shape of the laser beam and the light spot shape of the excited light by the configurations of the light spot shaping component, the first light homogenizing component, and the second light homogenizing component so that the etendue of the laser beam matches the etendue of the excited light, thereby increasing brightness and reducing speckles.

In view of the above description, the projection device of the present disclosure increases the contrast ratio of an image by the configurations of the aforementioned illumination system.

### BRIEF DESCRIPTION OF THE DRAWINGS

FIG. 1 depicts the block diagram of an illumination system according to one embodiment of the present disclosure.

FIG. 2 depicts the configuration diagram of a wavelength conversion component according to one embodiment of the present disclosure.

FIG. 3A depicts the configuration diagram of the illumination system according to one embodied aspect of FIG. 1.

FIG. 3B depicts the configuration diagram of a light source device according to one embodied aspect of the illumination system of FIG. 3A.

FIG. 3C depicts the configuration diagram of the illumination system according to another embodied aspect of FIG. 1.

FIG. 3D depicts the configuration diagram of a light source device and a polarization component according to one embodied aspect of the illumination system of FIG. 3C.

FIG. 4A depicts the timing diagram of the illumination system according to one embodiment of the present disclosure.

FIG. 4B depicts the timing diagram of the illumination system according to another embodiment of the present disclosure.

FIG. 5 depicts the configuration diagram of a projection device based on the illumination system shown in FIG. 3A.

FIG. 6 depicts the configuration diagram of the illumination system according to yet embodied aspect of FIG. 1.

FIG. 7 depicts the configuration diagram of a projection device based on the illumination system shown in FIG. 6.

FIG. 8 depicts the block diagram of an illumination system according to another embodiment of the present disclosure.

FIG. 9 depicts the configuration diagram of the illumination system according to one embodied aspect of FIG. 8.

FIG. 10 depicts the configuration diagram of a projection device based on the illumination system shown in FIG. 9.

### DETAILED DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as "top," "bottom," "front," "back," etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The illumination system of the present disclosure adapted to provide an illumination light beam and includes a light source device, a light spot shaping component, a wavelength conversion component, a first light homogenizing component, a light combining component, and a second light homogenizing component. The light source device is configured to emit a first color beam and a second color beam. The light spot shaping component is disposed on the travelling path of the first color beam and shapes the first color beam to form a first color shaping beam. The wavelength conversion component is disposed on the travelling path of the first color shaping beam and is configured to convert the first color shaping beam into excited light. The excited light and the first color shaping beam leave from the wavelength conversion component at different timing. The first light homogenizing component is disposed on the travelling path of the second color beam. The light combining component is disposed on the travelling path of the excited light, the travelling path of the first color shaping beam and the travelling path of the second color beam, and guides at least one part of the excited light, the first color shaping beam and the second color beam to the second light homogenizing component. The illumination beam includes at least one of at least one part of the excited light, the first color shaping beam and the second color beam.

The projection device of the present disclosure includes the aforementioned illumination system, a light valve, and a projection lens. The light valve is disposed on the travelling path of the illumination beam and converts the illumination beam into an image beam. The projection lens is disposed on the travelling path of the image beam and is configured to project the image beam outside the projection device. For example, the light valve is a reflective light modulator such as a liquid crystal on silicon panel (LCoS panel) and a digital micro-mirror device (DMD). In some embodiments, the light valve may also be a transmissive light modulator such as a transparent liquid crystal panel, an electro-optical modulator, a magneto-optic modulator and an acousto-optic modulator (AOM). The present disclosure does not limit the form and the type of the light valve. The comprehensive steps and the implementation of a method of converting the illumination beam into the image beam by the light valve may be implemented by obtaining adequate teaching, advice and explanation from ordinary knowledge in the art and not be repeated. In the present embodiment, the number of the light valve is one, e.g., the projection device using the single DMD, but the number of the light valve in other embodiments may be plural, and the present disclosure is not limited thereto.

For example, the projection lens includes the combinations of one or more optical lenses with diopters, and the combinations of one or more optical lenses with the diopters are the various combinations of non-planar lenses such as bi-concave lenses, bi-convex lenses, concavo-convex lenses, convexo-concave lenses, plano-convex lenses and plano-concave lenses. In one embodiment, the projection lens may further include a planar optical lens to project the image beam from the light valve onto a projection target outside the projection device. The present disclosure does not limit the form and the type of the projection lens.

In order to clearly understand the operation mechanisms of the illumination system and the projection device of the present disclosure, the following will elaborate the operation mechanisms of the illumination system and the projection device of the present disclosure by the embodiments and the accompanying drawings.

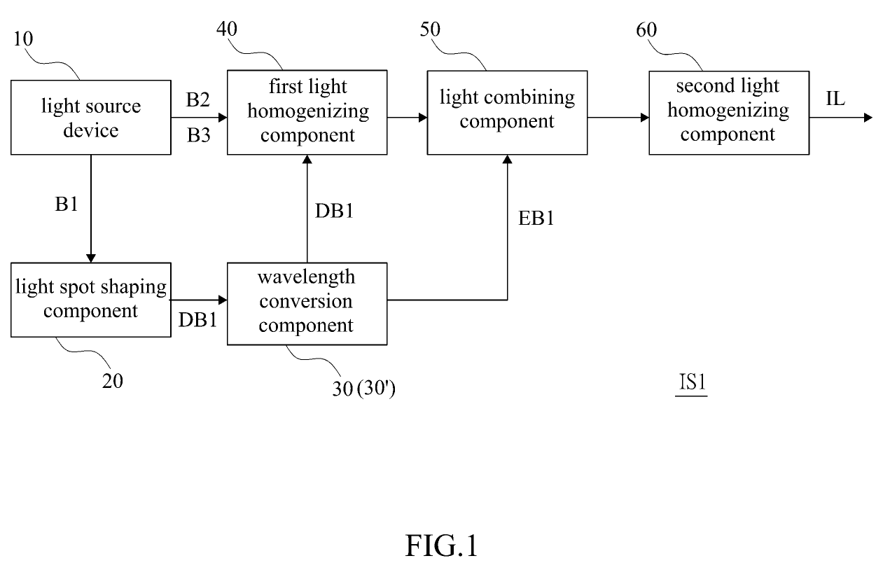

Please refer to FIG. 1, which depicts the block diagram of an illumination system according to one embodiment of the present disclosure. As shown in FIG. 1, the illumination system IS1 includes the light source device 10, the light spot shaping component 20, the wavelength conversion component 30(30’), the first light homogenizing component 40, the light combining component 50, and the second light homogenizing component 60.

In one embodiment, the light source device 10 is a solid-state light source and includes a first color light-emitting unit and a second color light-emitting unit. The first color light-emitting unit is configured to provide the first color beam B1, and the first color beam B1 is a blue laser beam and is transmitted to the light spot shaping component 20. The second color light-emitting unit is configured to provide the second color beam B2, and the second color beam B2 is a green laser beam or a red laser beam and is transmitted to the first light homogenizing component 40. For example, the first color light-emitting unit is a blue laser diode, the second color light-emitting unit is a green laser diode or a red laser diode, and the light spot shape of the first color beam B1 and the light spot shape of the second color beam B2 are all rectangles.

In another embodiment, light source device 10 is a solid-state light source and includes a first color light-emitting unit, a second color light-emitting unit, and a third color light-emitting unit. The first color light-emitting unit is configured to provide the first color beam B1, and the first color beam B1 is the blue laser beam and is transmitted to the light spot shaping component 20. The second color light-emitting unit is configured to provide the second color beam B2, and the second color beam B2 is the green laser beam and is transmitted to the first light homogenizing component 40. The third color light-emitting unit is configured to provide the third color beam B3, and the third color beam B3 is the red laser beam and is transmitted to the first light homogenizing component 40. For example, the first color light-emitting unit is the blue laser diode, the second color light-emitting unit is the green laser diode, and the third color light-emitting unit is the red laser diode; the light spot shape of the first color beam B1, the light spot shape of the second color beam B2 and the light spot shape of the third color beam B3 are all the rectangles.

The light spot shaping component 20 may be an anisotropic diffuser, a lens array component or a cylindrical lens array component. When being the anisotropic diffuser, the light spot shaping component 20 is provided with plenty of oval microstructures, and the oval microstructures are exemplarily disposed on YZ plane; when being the lens array component, the light spot shaping component 20 is provided with plenty of rectangular lens structures, and the rectangular lens microstructures are exemplarily disposed on the YZ plane; when being the cylindrical lens array component, the light spot shaping component 20 is provided with plenty of cylindrical lens structures, and the cylindrical lens structures are exemplarily disposed on the YZ plane and are arranged along z-axis. The light spot shaping component 20 is disposed on the travelling path of the first color beam B1 and shapes the first color beam B1 to form the first color shaping beam DB1, and the first color shaping beam DB1 is subsequently transmitted to the wavelength conversion component 30(30’); the light spot shaping component 20 is not located on the travelling path of the second color beam B2 and/or the travelling path of the third color beam B3. In other words, the light spot shaping component 20 is disposed between the light source device 10 and the wavelength conversion component 30(30’). The light spot shape of the first color beam B1 is different from or the same as the light spot shape of the first color shaping beam DB1; for example, the light spot shape formed by the first color shaping beam DB1 when being incident on the wavelength conversion component 30 is the rectangle. Specifically, the light spot shaping component 20 includes a transparent substrate and a plurality of shaped microstructures disposed on the transparent substrate, each shaped microstructure has a third aspect ratio, and preferably, the range of the third aspect ratio is 1.1~3. For example, the transparent substrate is a glass substrate, and the shape of each shaped microstructure is an ellipse, the rectangle or a circle. In the present embodiment, the shape of orthogonal projection on the transparent substrate of each shaped microstructure, for example, is the ellipse, the rectangle or the circle.

The wavelength conversion component 30(30’) is disposed on the travelling path of the first color shaping beam DB1 and is configured to convert the first color shaping beam DB1 into the excited light EB1. The excited light EB1 and the first color shaping beam DB1 leave from the wavelength conversion component 30(30’) at different timing. The first color shaping beam DB1 is sequentially transmitted to the first light homogenizing component 40, the light combining component 50 and the second light homogenizing component 60. The excited light EB1 is sequentially transmitted to the light combining component 50 and the second light homogenizing component 60, and the light spot shape of the excited light EB1 formed on the second light homogenizing component 60 is the circle. In other words, the first light homogenizing component 40 is not arranged on the travelling path of the excited light EB1 from the wavelength conversion component 30(30’). Because the excited light EB1 is excited when the first color shaping beam DB1 is incident on the wavelength conversion materials disposed on the wavelength conversion component 30, the wavelength range of the excited light EB1 is wider than the wavelength range of a monochromatic beam; for example, the excited light EB1 is yellow light, and the wavelength range of the excited light EB1 exemplarily encompasses one part of the wavelength range of red light and one part of the wavelength range of green light. In one embodiment, the wavelength range of the excited light EB1 at least partially overlaps the wavelength range of the second color beam; for example, the wavelength range of the excited light EB1 is the wavelength range of the yellow light, and the wavelength range of the second color beam is the wavelength range of the green light. In another embodiment, the wavelength range of the excited light EB1 (e.g., the wavelength range of the yellow light) at least partially overlaps the wavelength ranges of the green laser beam and the red laser beam.

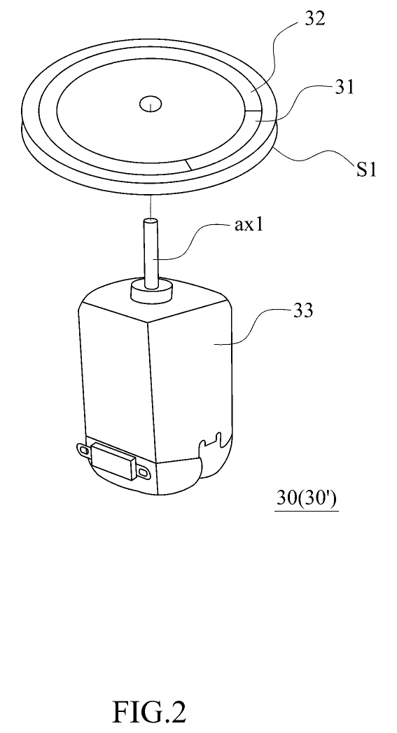

The following will introduce the configuration of the wavelength conversion component 30(30’). Please further refer to FIG. 2, which depicts the configuration diagram of the wavelength conversion component according to one embodiment of the present disclosure. As shown in FIG. 2, the wavelength conversion component 30(30’) includes a substrate S1 and a motor 33. A non-wavelength-converting region 31 and a wavelength-converting region 32 are located on substrate S1, and the substrate S1 may be a metal substrate or the transparent substrate, for example. In the present embodiment, the wavelength-converting region 32 is provided with the wavelength conversion materials to convert the first color shaping beam DB1 into the excited light EB1 with the needed color, and the wavelength conversion materials, for example, are phosphor materials, quantum dot (QD) materials or similar materials, e.g., silicate materials, silicon nitride materials, sulfide materials, QD materials, garnet materials or the other appropriate materials or the combination of the above materials. The non-wavelength-converting region 31 is configured to reflect the first color shaping beam DB1 or allow the first color shaping beam DB1 to pass through; the rotation axis ax1 of the motor 33 is connected to the center of the substrate S1. The motor 33 is adapted to drive the substrate S1 to rotate around the rotation axis ax1 so that the non-wavelength-converting region 31 and the wavelength-converting region 32 on the substrate S1 enter the travelling path of the first color shaping beam DB1 by turns. When the motor 33 drives the substrate S1 to rotate around the rotation axis ax1 and causes the non-wavelength-converting region 31 to be disposed on the travelling path of the first color shaping beam DB1, the non-wavelength-converting region 31 is configured to reflect the first color shaping beam DB1 or allow the first color shaping beam DB1 to pass through, and the first color shaping beam DB1 is subsequently guided to the first light homogenizing component 40. When the motor 33 drives the substrate S1 to rotate around the rotation axis ax1 and causes the wavelength-converting region 32 to be disposed on the travelling path of the first color shaping beam DB1, the wavelength-converting region 32 is configured to convert the first color shaping beam DB1 into the excited light EB1, and the excited light EB1 is reflected to the light combining component 50. A time point when the non-wavelength-converting region 31 is rotated to be disposed on the travelling path of the first color shaping beam DB1 is different from a time point when the wavelength-converting region 32 is rotated to be disposed on the travelling path of the first color shaping beam DB1.

In one embodiment, if the wavelength conversion component 30 is a reflective wavelength conversion component, a reflective layer (not shown) may be arranged at the position of the substrate S1 corresponding to the non-wavelength-converting region 31 and the wavelength-converting region 32 and be configured to reflect the first color shaping beam DB1 and the excited light EB1. In another embodiment, if the wavelength conversion component 30’ is a transmissive wavelength conversion component, the non-wavelength-converting region 31 is a transmissive region and is configured to allow the first color shaping beam DB1 to pass through. If the substrate S1 is the metal substrate, a through hole (not shown) may be arranged to be configured to allow the first color shaping beam DB1 to pass through. The reflective layer may be arranged at the position of the substrate S1 corresponding to the wavelength-converting region 32 to reflect the excited light EB1. It should be noted that only one of the wavelength conversion components 30 and 30’ requires arranging on the illumination system IS1, and the number of the wavelength conversion component in the illumination system IS1 is one.

In one embodiment, the first light homogenizing component 40 is disposed on the travelling path of the first color shaping beam DB1 and the travelling path of the second color beam B2, and the first color shaping beam DB1 and the second color beam B2 pass through the first light homogenizing component 40 and are transmitted to the light combining component 50. In other words, the light incident surface of the first light homogenizing component 40 faces the light device 10, the light exit surface of the first light homogenizing component 40 is farther away from the light source device 10 than the light incident surface, and the first light homogenizing component 40 is disposed between the light source device 10 and the light combining component 50. In another embodiment, the first light homogenizing component 40 is disposed on the travelling path of the first color shaping beam DB1, the travelling path of the second color beam B2 and the travelling path of the third color beam B3, and the first color shaping beam DB1, the second color beam B2 and the third color beam B3 pass through the first light homogenizing component 40 and are transmitted to the light combining component 50. According to the aforementioned descriptions, the light incident surface of the first light homogenizing component 40 faces the light source device 10, and the first light homogenizing component 40 is disposed between the light source device 10 and the light combining component 50.

Specifically, the first light homogenizing component 40 includes a first substrate and a plurality of first microstructures disposed on the first substrate, and each first microstructure has a first aspect ratio. Preferably, the range of the first aspect ratio is 1.1~3, but the third aspect ratio is different from the first aspect ratio. The shape of the orthogonal projection on the first substrate of each first microstructure is different from the shape of the orthogonal projection on the transparent substrate of each shaped microstructure. For example, the first light homogenizing component is a fly-eye lens, the first microstructures is a first microlens array, and the shape of the first microstructure is a hexagon; the light spot shape of a beam received by the light incident surface of the first light homogenizing component 40 is the rectangle, and the shape of the angular distribution of the beam received by the light incident surface of the first light homogenizing component 40 is the circle . The first light homogenizing component 40 may be an integrated component with a dual surface structure or two split components with single surface structures, and the aforementioned first microstructures, for example, may be disposed on one surface of the integrated component with the dual surface structure or be disposed on one of two split components with the single surface structures.

In one embodiment, the light combining component 50 is disposed on the travelling path of the excited light EB1, the travelling path of the first color shaping beam DB1, and the travelling path of the second color beam B2 and guides at least one part of the excited light EB1, the first color shaping beam DB1, and the second color beam B2 to the second light homogenizing component 60. In another embodiment, the light combining component 50 is disposed on the travelling path of the excited light EB1, the travelling path of the first color shaping beam DB1, the travelling path of the second color beam B2, and the travelling path of the third color beam B3 and guides at least one part of the excited light EB1, the first color shaping beam DB1, the second color beam B2, and the third color beam B3 to the second light homogenizing component 60.

According to the aforementioned descriptions, the light combining component 50 is disposed between the first light homogenizing component 40 and the second light homogenizing component 60. In one embodiment, the light combining component 50, for example, is a dichroic mirror which is configured to allow at least one part of the excited light EB1 to pass through and to reflect the first color shaping beam DB1, the second color beam B2, and the third color beam B3. The light combining component 50, for example, is configured to reflect in the wavelength range of the first color shaping beam DB1, the second color beam B2, and the third color beam B3 from the first light homogenizing component 40, and a part of the excited light EB1 with wavelengths overlapping the wavelength ranges of the second color beam B2 and the third color beam B3 would not pass through the light combining component 50. Furthermore, the light combining component 50 is configured to reflect the beam in the wavelength range less than 425nm, the beam in the wavelength range from 475nm to 500nm, and the beam in the wavelength range from 550nm to 625nm and to allow the beams with the other wavelengths in a visible spectrum to pass through. In another embodiment, the light combining component 50, for example, is the dichroic mirror which is configured to reflect a part of the excited light EB1 and to allow the first color shaping beam DB1, the second color beam B2, and the third color beam B3 to pass through, and a part of the excited light EB1 with wavelengths overlapping the wavelength ranges of the second color beam B2 and the third color beam B3 would not be reflected by the light combining component 50. Furthermore, the light combining component 50 is configured to allow the beam in the wavelength range less than 425nm, the beam in the wavelength range from 475nm to 500nm, and the beam in the wavelength range from 550nm to 625nm to pass through and to reflect the beams with the other wavelengths in the visible spectrum.

In one embodiment, the second light homogenizing component 60 is disposed on the travelling path of at least one part of the excited light EB1, the travelling path of the first color shaping beam DB1 and the travelling path of the second color beam B2, and the illumination beam is formed by at least one of at least one part of the excited light EB1, the first color shaping beam DB1, and the second color beam B2 which pass through the second light homogenizing component 60. In another embodiment, the second light homogenizing component 60 is disposed on the travelling path of at least one part of the excited light EB1, the travelling path of the first color shaping beam DB1, the travelling path of the second color beam B2, and the travelling path of the third color beam B3, and the illumination beam is formed by at least one of at least one part of the excited light EB1, the first color shaping beam DB1 and the second color beam B2, and the third color beam B3 which pass through the second light homogenizing component 60.

Specifically, the second light homogenizing component 60 includes a second substrate and a plurality of second microstructures disposed on the second substrate, and each second microstructure has a second aspect ratio. Preferably, the range of the second aspect ratio is 1.1~3, and the third aspect ratio is similar to or approximates the second aspect ratio. The shape of the orthogonal projection on the second substrate of each second microstructure is different from the shape of the orthogonal projection on the first substrate of each first microstructure. For example, the second light homogenizing component is the fly-eye lens, the second microstructures is a second microlens array, and the shape of the second microstructure is the rectangle. The light spot shape of a beam received by the light incident surface of the second light homogenizing component 60 is the circle, and the shape of the angular distribution of the beam received by the light incident surface of the second light homogenizing component 60 is the rectangle. By the configurations of the first light homogenizing component 40 and the second light homogenizing component 60, the light spot of the first color shaping beam DB1 after passing through the first light homogenizing component 40 matches the second aspect ratio of the second light homogenizing component 60. The second light homogenizing component 60 may be the integrated component with the dual surface structure or two split components with the single surface structures, and the aforementioned second microstructures, for example, may be disposed on one surface of the integrated component with the dual surface structure or be disposed on one of two split components with the single surface structures.

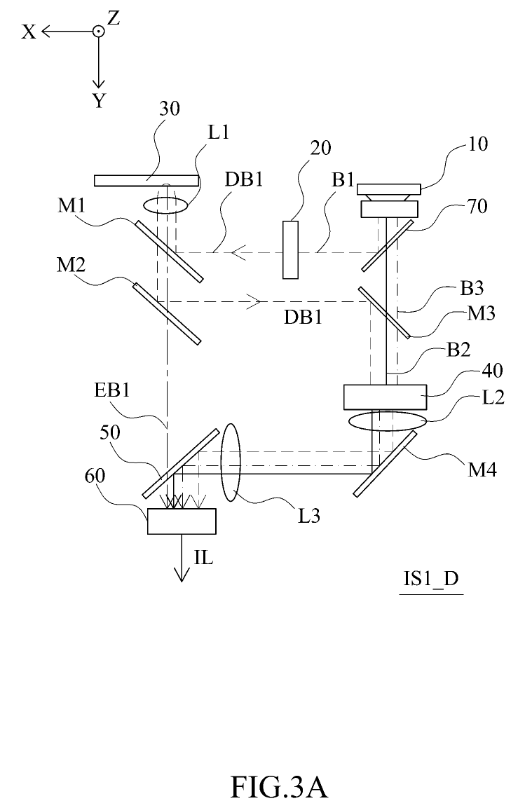

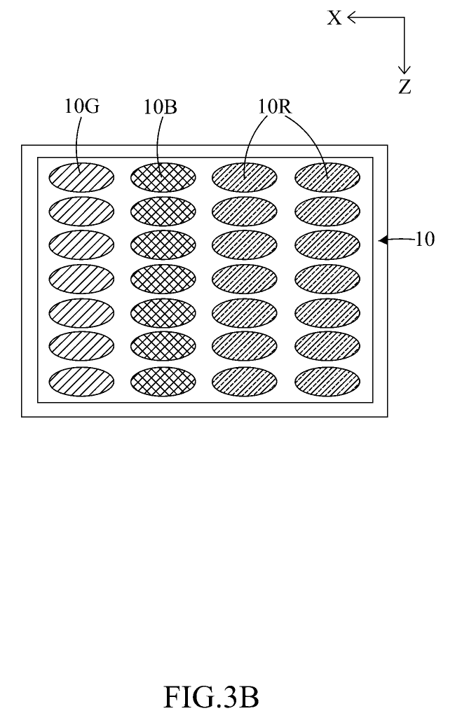

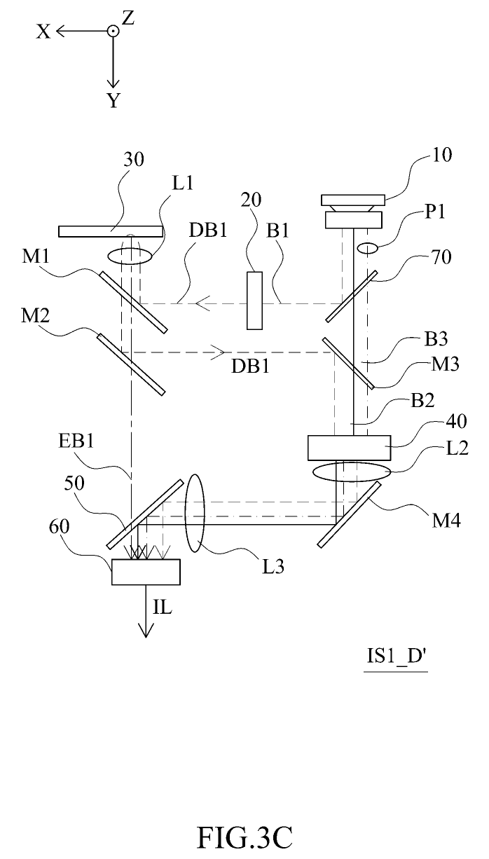

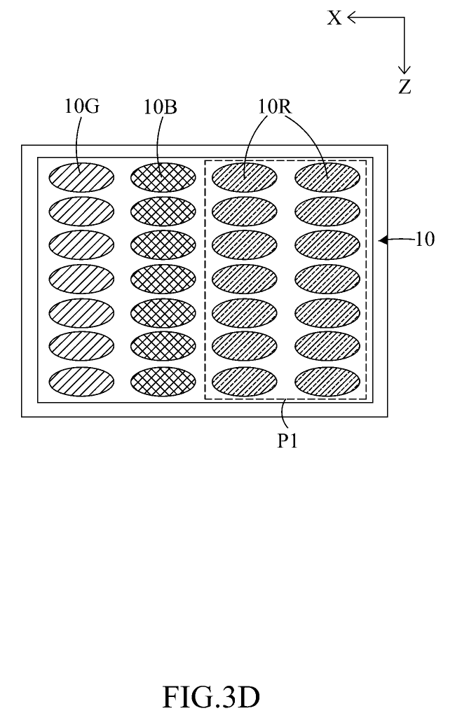

Please refer to FIG. 3A and FIG. 3B, which depict the configuration diagram of the illumination system according to one embodied aspect of FIG. 1 and the configuration diagram of the light source device according to one embodied aspect of the illumination system of FIG. 3A. As shown in FIG. 3A and FIG. 3B, the illumination system IS1_D includes the light source device 10, the light spot shaping component 20, the wavelength conversion component 30, the first light homogenizing component 40, the light combining component 50, the second light homogenizing component 60, a dichroic mirror 70, dichroic mirrors M1~M3, a reflective component M4, and lenses L1~L3. The configurations of the light source device 10, the light spot shaping component 20, the wavelength conversion component 30, the first light homogenizing component 40, the light combining component 50, and the second light homogenizing component 60 shown in FIG. 3A are almost similar to the configurations of the light source device 10, the light spot shaping component 20, the wavelength conversion component 30, the first light homogenizing component 40, the light combining component 50, and the second light homogenizing component 60 shown in FIG. 1 and are not repeated.

In the embodiment of FIG. 3B, the light source device 10 includes the first color light-emitting unit 10B, the second color light-emitting unit 10G and the third color light-emitting unit 10R which are configured to respectively provide the first color beam B1, the second color beam B2, and the third color beam B3. In the present embodiment, light source device 10 includes one first color light-emitting unit 10B, one second color light-emitting unit 10G, and two third color light-emitting units 10R, and the second color light-emitting unit 10G, the first color light-emitting unit 10B, and the third color light-emitting units 10R, for example, are sequentially arranged along a direction parallel to x-axis. The first color light-emitting unit 10B, for example, includes the plenty of blue laser diodes arranged along the z-axis; the second color light-emitting unit 10G, for example, includes the plenty of green laser diodes arranged along the z-axis; two third color light-emitting units 10R, for example, includes two columns of red laser diodes disposed along the x-axis, and each column of red laser diodes includes the plenty of red laser diodes arranged along the z-axis. In one embodiment, the first color light-emitting unit 10B, the second color light-emitting unit 10G, and the third color light-emitting units 10R, for example, are encapsulated in the same package (light source device).

In another embodied aspect, the number of the first color light-emitting units 10B in the light source device 10, the number of the second color light-emitting units 10G in the light source device 10, and the number of third color light-emitting units 10R in the light source device 10 may be separately plural.

In another embodied aspect, the number of the light source devices 10 may be plural, and each light source device 10 includes the plenty of light-emitting units with different types. For example, the number of the light source devices 10 is three, one light source device 10 includes the plenty of first color light-emitting units 10B, another light source device 10 includes the plenty of second color light-emitting units 10G, and the other light source device 10 includes the plenty of third color light-emitting units 10R. By the aforementioned configuration, the heat dissipation effect of the light source device 10 are improved.

As shown in FIG. 3A and FIG. 3B, the wavelength conversion component 30 of the illumination system IS1_D is the reflective wavelength conversion component. The dichroic mirror 70 is located between the light source device 10 and the first light homogenizing component 40. Preferably, the first color beam B1, the second color beam B2 and the third color beam B3 are guided to the dichroic mirror 70 through the combination of at least one dichroic mirror and at least one reflector. The light spot shaping component 20 is located between the dichroic mirror 70 and the wavelength conversion component 30. The dichroic mirror 70 guides the second color beam B2 and the third color beam B3 to the first light homogenizing component 40 and guides the first color beam B1 to the light spot shaping component 20 .

The dichroic mirror M1 is located on the travelling path of the first color shaping beam DB1 from the light spot shaping component 20 and guides the first color shaping beam DB1 to the wavelength conversion component 30, the wavelength conversion component 30 converts the first color shaping beam DB1 into the excited light EB1, and the excited light EB1 passes through the dichroic mirror M1 and is transmitted to the dichroic mirror M2. It should be noted that the dichroic mirror M1 includes a first region and a second region which are disposed adjacent to each other. The first region is configured to reflect the first color shaping beam DB1 and to allow the excited light EB1 to pass through, i.e., the first region, for example, may be a region which reflects the blue beam and allows the beams with the other wavelengths in the visible spectrum except the blue beam to pass through; the second region is configured to allow the first color shaping beam DB1 and the excited light EB1 to pass through, i.e., the second region, for example, may be a region which allows the beams in the visible spectrum to pass through. The first color shaping beam DB1 is incident on the first region and is reflected by the first region, the reflected first color shaping beam DB1 is obliquely incident by the lens L1 and is converged on the non-wavelength-converting region 31 of the wavelength conversion component 30, and the non-wavelength-converting region 31 of the wavelength conversion component 30 reflects the first color shaping beam DB1 so that the reflected first color shaping beam DB1 is transmitted to the dichroic mirror M1 by the lens L1 and passes through the second region of the dichroic mirror M1.

The dichroic mirror M2 is located on the travelling path of the first color shaping beam DB1 and the travelling path of the excited light EB1. The dichroic mirror M2 is also located between the dichroic mirror M1 and light combining component 50, and guides the first color shaping beam DB1 to the dichroic mirror M3 which is located between the dichroic mirror 70 and the first light homogenizing component 40, for example. The excited light EB1 passes through the dichroic mirror M2 and is transmitted to the light combining component 50. The dichroic mirror M3 is located on the travelling path of the first color shaping beam DB1, the travelling path of the second color beam B2, and the travelling path of the third color beam B3 and guides the first color shaping beam DB1, the second color beam B2, and the third color beam B3 to the first light homogenizing component 40.

The lens L2, the lens L3, and the reflective component M4 are all located on the travelling path of the first color shaping beam DB1, the travelling path of the second color beam B2, and the travelling path of the third color beam B3. After passing through the first light homogenizing component 40, the first color shaping beam DB1, the second color beam B2, and the third color beam B3 enter the lens L2 and are transmitted to the reflective component M4, the reflective component M4 reflects the first color shaping beam DB1, the second color beam B2, and the third color beam B3, and the reflected first color shaping beam DB1, the reflected second color beam B2, and the reflected third color beam B3 enter the lens L3 and are incident on the light combining component 50. The light combining component 50 of the present embodiment is similar to the light combining component 50 shown in FIG. 1 to be configured to guide at least one part of the excited light EB1, the first color shaping beam DB1, the second color beam B2, and the third color beam B3 to the second light homogenizing component 60.

In another embodied aspect, the light source device 10 includes the first color light-emitting unit and the second color light-emitting unit, and the illumination system further includes a filter wheel (not shown). The filter wheel, for example, includes a blue filter (or a transparency), a green filter, and a red filter and is adapted to rotate so that the blue filter (or a transparency), the green filter, and the red filter sequentially correspond to the light incident surface of the second light homogenizing component 60. The filter wheel is disposed between the light combining component 50 and the second light homogenizing component 60. For example, the second color beam B2 provided by the second color light-emitting unit is the green laser beam, and the dichroic mirror M1 guides the first color shaping beam DB1 to the wavelength-converting region 32 to generate the excited light EB1; the excited light EB1, for example, is yellow-red light (yellow-orange color) and is transmitted to the light combining component 50 after sequentially passing through the dichroic mirrors M1 and M2, and the light combining component 50 guides at least one part of the excited light EB1 to the filter wheel. When the excited light EB1 enters the red filter of the filter wheel, the red light part of the excited light EB1 passes through the red filter of the filter wheel to form and to serve as the red beam of the illumination beam.

Please refer to FIG. 3C and FIG. 3D, which depict the configuration diagram of the illumination system according to another embodied aspect of FIG. 1 and the configuration diagram of the light source device and the polarization component according to one embodied aspect of the illumination system of FIG. 3C. The configuration of the illumination system IS1_D’ of the present embodied aspect is similar to the configuration of the illumination system IS1_D shown in FIG. 3A, but there is the difference between the illumination system IS1_D’ and the illumination system IS1_D: as shown in FIG. 3C and FIG. 3D, the illumination system IS1_D’ further includes a polarization component P1 disposed between the first light homogenizing component 40 and the light source device 10; for example, the polarization component P1 is a half-wave plate. In the embodiment of FIG. 3D, the light source device 10 includes the first color light-emitting unit 10B, the second color light-emitting unit 10G, and two third color light-emitting units 10R, and the second color light-emitting unit 10G, the first color light-emitting unit 10B, and two third color light-emitting units 10R, for example, are sequentially arranged along the direction parallel to the x-axis. The first color light-emitting unit 10B , for example, includes the plenty of blue laser diodes arranged along the z-axis; the second color light-emitting unit 10G, for example, includes the plenty of green laser diodes arranged along the z-axis; two third color light-emitting units 10R, for example, includes two columns of red laser diodes disposed along the x-axis, and each column of red laser diodes includes the plenty of red laser diodes arranged along the z-axis. The first color light-emitting unit 10B, the second color light-emitting unit 10G, and the third color light-emitting units 10R, for example, are encapsulated in the same package (light source device).

In the present embodied aspect, the polarization component P1 is arranged on the travelling path of the red laser beam (the third color beam B3) provided by the third color light-emitting unit 10R and is configured to change the polarization state of the red laser beam (the third color beam B3) so that the polarization state of the changed red laser beam is the same as the polarization states of the blue laser beam (first color beam B1) and the green laser beam (the second color beam B2). In another embodied aspect, the polarization component P1 is arranged on the travelling path of the blue laser beam (the first color beam B1) and the travelling path of the green laser beam (the second color beam B2) and is configured to change the polarization states of the blue laser beam (the first color beam B1) and the green laser beam (the second color beam B2). For example, the polarization component P1 is disposed between the first color light-emitting unit 10B, the second color light-emitting unit 10G, and the dichroic mirror 70. Before the blue laser beam (the first color beam B1) and the green laser beam (the second color beam B2) are incident on the dichroic mirror 70, the polarization component P1 changes the polarization state of the blue laser beam (the first color beam B1) and the polarization state of the green laser beam (the second color beam B2), and the polarization state of the changed blue laser beam (the first color beam B1) and the polarization state of the changed green laser beam (the second color beam B2) are the same as the polarization state of the red laser beam (third color beam B3) .

In another embodied aspect, a movable diffuser (not shown) may be further disposed between the light source device 10 and the first light homogenizing component 40. By the configuration of the movable diffuser, a speckle phenomenon generated by the laser beam of the illumination system is reduced.

In another embodied aspect, the polarization component P1 may not be disposed on the illumination system. The illumination system may further include a depolarizer (not shown) disposed between the light source device 10 and the first light homogenizing component 40 or between the first light homogenizing component 40 and the second light homogenizing component 60, and by the foregoing configuration, the polarization state of the blue laser beam, the polarization state of the green laser beam and the polarization state of the red laser beam may be eliminated, thereby reducing the speckle phenomenon generated by the laser beam of the illumination system.

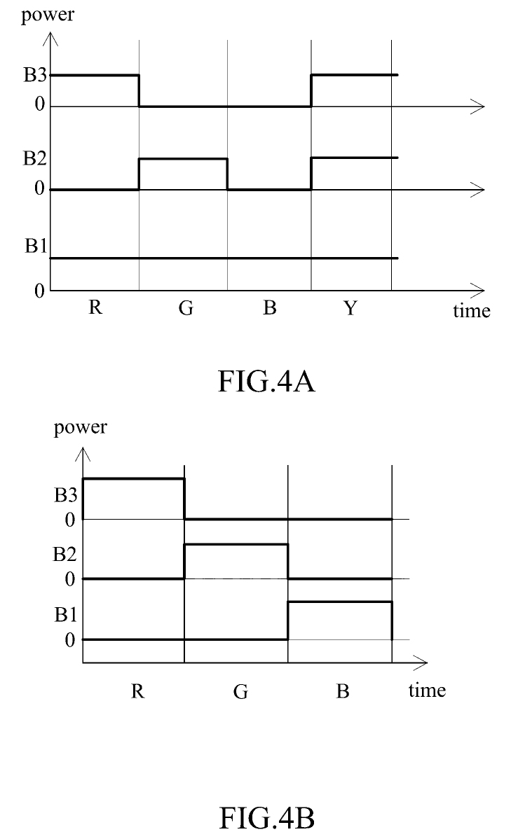

The following will introduce the workings of the illumination system shown in FIG. 3A and the light source device shown in FIG. 3B during different periods. Please further refer to FIG. 4A, which depicts the timing diagram of the illumination system according to one embodiment of the present disclosure. As shown in FIG. 4A, FIG. 3A and FIG. 3B, the timing of the first color beam B1 of the first color light-emitting unit 10B, the timing of the second color beam B2 of the second color light-emitting unit 10G, and the timing of the third color beam B3 of the third color light-emitting unit 10R are different from one another, wherein the first color beam B1 is the blue laser beam, the second color beam B2 is the green laser beam, and the third color beam B3 is the red laser beam.

During red beam timing R, the first color light-emitting unit 10B and the third color light-emitting unit 10R are turned on, and the second color light-emitting unit 10G is turned off. The third color beam B3 (the red laser beam) , for example, sequentially passes through the dichroic mirror 70 and the dichroic mirror M3 along y-axis and is transmitted to the first light homogenizing component 40. Afterwards, the lens L2, the reflective component M4, and the lens L3 guide the third color beam B3 to the light combining component 50, wherein the reflective component M4 is configured to change the travelling direction of the third color beam B3 along the y-axis into that of the third color beam B3 which is transmitted to the light combining component 50 along the x-axis. At present, the first color beam B1 provided by the first color light-emitting unit 10B passes through the light spot shaping component 20 along the x-axis after being reflected by the dichroic mirror 70, and the light spot shaping component 20 shapes the first color beam B1 to form the first color shaping beam DB1. Meanwhile, the wavelength-converting region 32 enters the travelling path of the first color shaping beam DB1, the first region of the dichroic mirror M1 reflects the first color shaping beam DB1 to the wavelength-converting region 32, the wavelength-converting region 32 converts the first color shaping beam DB1 into the excited light EB1 (e.g., the yellow light), and the excited light EB1 sequentially passes through the dichroic mirrors M1 and M2 along the y-axis and is transmitted to the light combining component 50. Finally, the light combining component 50 guides at least one part of the excited light EB1 and the third color beam B3 to the second light homogenizing component 60, and at least one part of the excited light EB1 and the red laser beam which leave from the second light homogenizing component 60 serve as the illumination beam (the red beam).

During green beam timing G, the third color light-emitting unit 10R is turned off, and the first color light-emitting unit 10B and the second color light-emitting unit 10G are turned on. The second color beam B2 (the green laser beam) from the second color light-emitting unit 10G sequentially passes through the dichroic mirror 70 and the dichroic mirror M3 along the y-axis and is transmitted to the first light homogenizing component 40. Afterwards, the lens L2, the reflective component M4, and the lens L3 guide the second color beam B2 to the light combining component 50, wherein the reflective component M4 is configured to change the travelling direction of the second color beam B2 along the y-axis into that of the second color beam B2 which is transmitted to the light combining component 50 along the x-axis. At present, the first color beam B1 provided by the first color light-emitting unit 10B passes through the light spot shaping component 20 along the x-axis after being reflected by the dichroic mirror 70, and the light spot shaping component 20 shapes the first color beam B1 to form the first color shaping beam DB1. Meanwhile, the wavelength-converting region 32 enters the travelling path of the first color shaping beam DB1, the first region of the dichroic mirror M1 reflects the first color shaping beam DB1 to the wavelength-converting region 32, the wavelength-converting region 32 converts the first color shaping beam DB1 into the excited light EB1, and the excited light EB1 sequentially passes through the dichroic mirrors M1 and M2 along the y-axis and is transmitted to the light combining component 50. Finally, the light combining component 50 guides at least one part of the excited light EB1 and the second color beam B2 to the second light homogenizing component 60, and at least one part of the excited light EB1 and the green laser beam which leave from the second light homogenizing component 60 serve as the illumination beam (the green beam).

During blue beam timing B, the second color light-emitting unit 10G and the third color light-emitting unit 10R are turned off, and the first color light-emitting unit 10B is turned on. The first color beam B1 provided by the first color light-emitting unit 10B passes through the light spot shaping component 20 along the x-axis after being reflected by the dichroic mirror 70, and the light spot shaping component 20 shapes the first color beam B1 to form the first color shaping beam DB1. Meanwhile, the non-wavelength-converting region 31 enters the travelling path of the first color shaping beam DB1, and the first region of the dichroic mirror M1 reflects the first color shaping beam DB1 to the non-wavelength-converting region 31, and the second region of the dichroic mirror M1, the dichroic mirror M2, and the dichroic mirror M3 guide the first color shaping beam DB1 from the non-wavelength-converting region 31 to the first light homogenizing component 40. The first color shaping beam DB1 is incident on the lens L2 after passing through the first light homogenizing component 40, and the lens L2, the reflective component M4, and the lens L3 guide the first color shaping beam DB1 to the light combining component 50. Finally, the light combining component 50 guides the first color shaping beam DB1 to the second light homogenizing component 60, and the first color shaping beam DB1 which leaves from the second light homogenizing component 60 serves as the illumination beam (the blue beam).

During yellow beam timing Y, the first color light-emitting unit 10B, the second color light-emitting unit 10G and the third color light-emitting unit 10R are turned on. The third color beam B3 (the red laser beam) and the second color beam B2 (the green laser beam) pass through the dichroic mirror 70 and the dichroic mirror M3 and are transmitted to the first light homogenizing component 40.Afterwards, the lens L2, the reflective component M4, and the lens L3 guide the third color beam B3 (the red laser beam) and the second color beam B2 (the green laser beam) to the light combining component 50. The light spot shaping component 20 shapes the first color beam B1 to form the first color shaping beam DB1. Meanwhile, the wavelength-converting region 32 enters the travelling path of the first color shaping beam DB1, the first region of the dichroic mirror M1 reflects the first color shaping beam DB1 to the wavelength-converting region 32, the wavelength-converting region 32 converts the first color shaping beam DB1 into the excited light EB1, and the excited light EB1 sequentially passes through the dichroic mirrors M1 and M2 and is transmitted to the light combining component 50. Finally, the light combining component 50 guides at least one part of the excited light EB1, the third color beam B3 (the red laser beam) , and the second color beam B2(the green laser beam) to the second light homogenizing component 60, and at least one part of the excited light EB1, the third color beam B3 (the red laser beam), and the second color beam B2(the green laser beam) which leave from the second light homogenizing component 60 serve as the illumination beam (the yellow beam).

Please refer to FIG. 4B, which depicts the timing diagram of the illumination system according to another embodiment of the present disclosure. As shown in FIG. 4B, FIG. 3A and FIG. 3B, the difference between the timing diagram shown in FIG. 4B and the timing diagram shown in FIG. 4A: without the yellow beam timing Y, and the first color light-emitting unit 10B is separately turned off during the red beam timing R and the green beam timing G. During the red beam timing R, the third color light-emitting unit 10R is turned on, and the first color light-emitting unit 10B and the second color light-emitting unit 10G are turned off. The third color beam B3 (the red laser beam) passes through the dichroic mirror 70 and the dichroic mirror M3 and is transmitted to the first light homogenizing component 40. Afterwards, the lens L2, the reflective component M4, and the lens L3 guide the third color beam B3 to the light combining component 50. Finally, the light combining component 50 guides the third color beam B3 to the second light homogenizing component 60, and the third color beam B3 leaving from the second light homogenizing component 60 serves as the illumination beam (the red beam).

During the green beam timing G, the second color light-emitting unit 10G is turned on, and the first color light-emitting unit 10B and the third color light-emitting unit 10R are turned off. The second color beam B2 passes through the dichroic mirror 70 and the dichroic mirror M3 and is transmitted to the first light homogenizing component 40. Afterwards, the lens L2, the reflective component M4, and the lens L3 guide the second color beam B2 to the light combining component 50. Finally, the light combining component 50 guides the second color beam B2 to the second light homogenizing component 60, and the second color beam B2 leaving from the second light homogenizing component 60 serves as the illumination beam (the green beam).

During the blue beam timing B, the first color light-emitting unit 10B is turned on, and the second color light-emitting unit 10G and the third color light-emitting unit 10R are turned off. The light spot shaping component 20 shapes the first color beam B1 to form the first color shaping beam DB1, the non-wavelength-converting region 31 enters the travelling path of the first color shaping beam DB1, the non-wavelength-converting region 31 reflects the first color shaping beam DB to the dichroic mirror M1, and the dichroic mirror M1, the dichroic mirror M2, and the dichroic mirror M3 guide the first color shaping beam DB1 from the non-wavelength-converting region 31 to the first light homogenizing component 40. The first color shaping beam DB1 is incident on the lens L2 after passing through the first light homogenizing component 40, and the lens L2, the reflective component M4, and the lens L3 guide the first color shaping beam DB1 to the light combining component 50. Finally, the light combining component 50 guides the first color shaping beam DB1 to the second light homogenizing component 60, and the first color shaping beam DB1 which leaves from the second light homogenizing component 60 serves as the illumination beam (the blue beam).

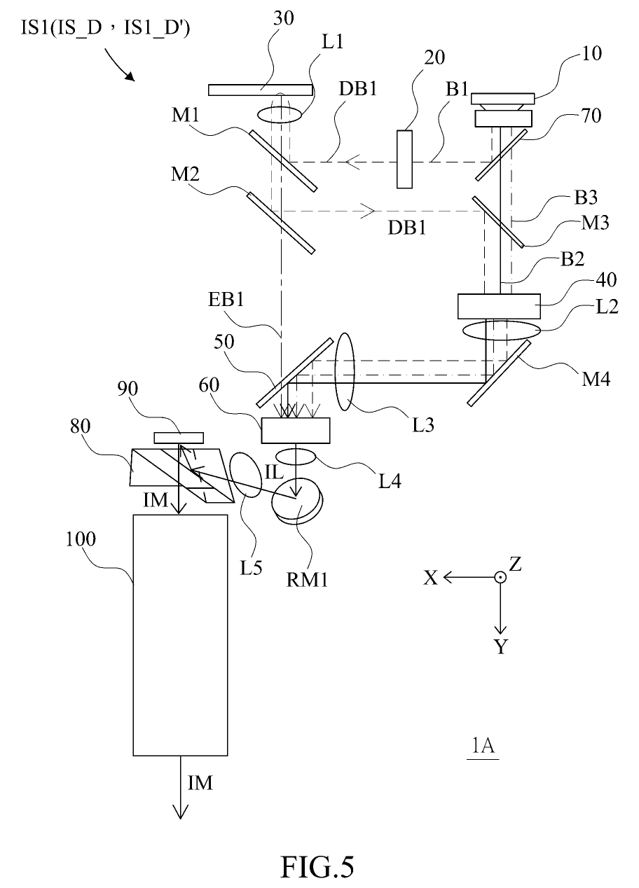

Please refer to FIG. 5, which depicts the configuration diagram of the projection device based on the illumination system shown in FIG. 3A. As shown in FIG. 5, the projection device includes the illumination system IS1 of FIG. 1 (i.e., the illumination system IS1_D of FIG. 3A or the illumination system IS1_D’ of FIG. 3B), lenses L4 and L5, a reflector RM1, a total internal reflection (TIR) prism 80, the light valve 90, and the projection lens 100.

The lenses L4 and L5, the reflector RM1, the TIR prism 80, and the light valve 90 are all disposed on the travelling path of the illumination beam IL. The projection lens is disposed on the travelling path of the image beam IM. The lenses L4 and L5 and the reflector RM1 guide the illumination beam IL to the TIR prism 80, the TIR prism 80 guides the illumination beam IL to the light valve 90, and the light valve 90 converts the illumination beam IL into the image beam IM. The image beam IM passes through the TIR prism 80 and is transmitted to the projection lens 100.

The light valve, for example, is the DMD and is provided with a plurality of micromirrors, each micromirror has a micromirror aspect ratio, the third aspect ratio is similar to or approximates the micromirror aspect ratio, and preferably, the range of the third aspect ratio is 1.1~3. When the light spot shaping component 20 is the anisotropic diffuser, and the shape of each shaped microstructure is the ellipse, the angular distribution of the first color beam B1 is widen by the shaped microstructure to approach the rectangle of which the aspect ratio is 16:9 to form the first color shaping beam DB1, and the angular distribution of the first color shaping beam DB1 corresponds to the ratio of the beam angle of the long axis and the beam angle of the short axis of the second light homogenizing component 60 and the third aspect ratio of the light valve 90, and the angular distribution of the excited light EB1 corresponds to the ratio of the beam angle of the long axis and the beam angle of the short axis of the second light homogenizing component 60. Hence, in the projection device of the present disclosure, the light spot of the excited light matches the light spot of the laser beam, thus improving the color uniformity. Although the shape (i.e., the rectangle) of the angular distribution of the first color shaping beam DB1 may be different from the acceptable shape (i.e., the circle) of the angular distribution of the beam received by the light incident surface of the first light homogenizing component 40, the area of the shape of the angular distribution of the first color shaping beam DB1 is less than the area of the acceptable shape of the angular distribution (i.e., the circle ) of the beam received by the light incident surface of the first light homogenizing component 40. Correspondingly, the first color beam B1 after passing through the light spot shaping component 20 (i.e., the first color shaping beam DB1) is coupled into the first light homogenizing component 40.

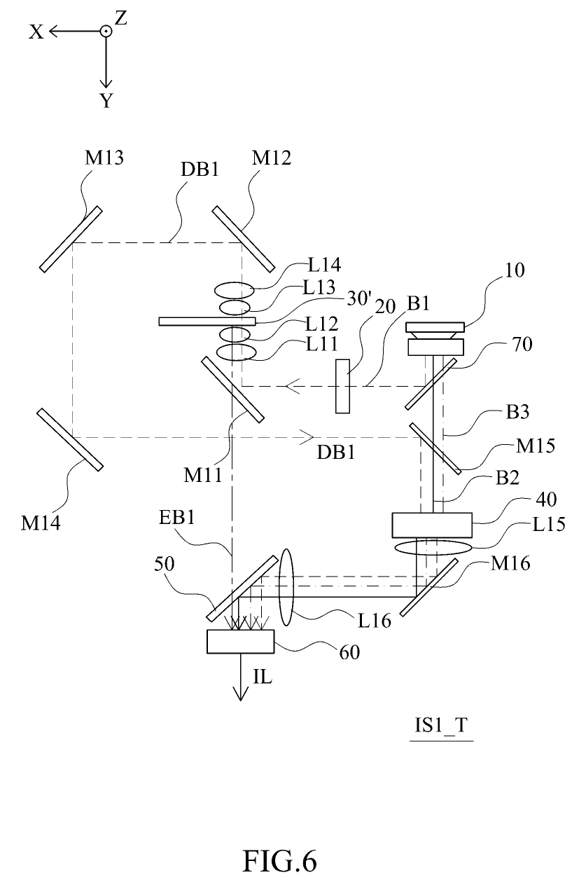

Please refer to FIG. 6, which depicts the configuration diagram of the illumination system according to yet embodied aspect of FIG. 1. As shown in FIG. 6, the illumination system IS1_T includes the light source device 10, the light spot shaping component 20, the wavelength conversion component 30’, the first light homogenizing component 40, the light combining component 50, the second light homogenizing component 60, the dichroic mirror 70, dichroic mirrors M11~M16 and lenses L11~L16. The light source device 10, the light spot shaping component 20, the first light homogenizing component 40, the light combining component 50, the second light homogenizing component 60, the dichroic mirror 70, the dichroic mirrors M11, M15 and M16, and the lenses L15 and L16 shown in FIG. 6 are similar to the light source device 10, the light spot shaping component 20, the first light homogenizing component 40, the light combining component 50, the second light homogenizing component 60, the dichroic mirror 70, the dichroic mirrors M1, M3 and M4, and the lenses L2 and L3 shown in FIG. 3A and are not repeated. The wavelength conversion component 30’ of the present embodiment is the transmissive wavelength conversion component.

The first color shaping beam DB1 passes through the lenses L11 and L12, the non-wavelength-converting region 31 of the wavelength conversion component 30’, and the lens L13 and L14 and enters the dichroic mirror M12, and the dichroic mirrors M12, M13 and M14 guide the first color shaping beam DB1 to the dichroic mirror M15. Afterwards, the dichroic mirror M15 guides the first color shaping beam DB1 to the first light homogenizing component 40, the first light homogenizing component 40 is configured to change the light spot shape of the first color shaping beam DB1 , and the light spot shape of the changed first color shaping beam DB1 corresponds to the light spot shape of the beam received by the light incident surface of the second light homogenizing component 60. The reflective component M16 and lenses L15 and L16 guide the first color shaping beam DB1 changed by the first light homogenizing component 40 to the second light homogenizing component 60. In another embodiment, the dichroic mirrors M12, M13 and M14 may be reflective mirrors and be configured to guide the first color shaping beam DB1 passing through the non-wavelength-converting region 31 of the wavelength conversion component 30’ to the dichroic mirror M15.

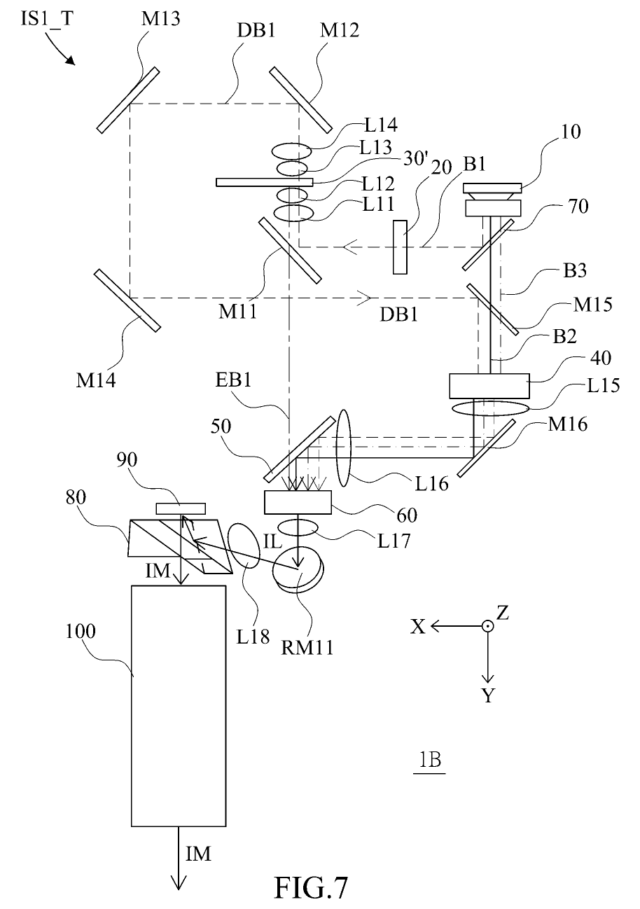

Please refer to FIG. 7, which depicts the configuration diagram of the projection device based on the illumination system shown in FIG. 6. As shown in FIG. 7, the projection device includes the illumination system of FIG. 6, the lenses L17 and L18, the reflector RM11, the TIR prism 80, the light valve 90 and the projection lens 100. The optical path of the illumination system which is the same as the illumination system IS1_T shown in FIG. 6 would not be repeated; the lenses L17 and L18 and the reflector RM11 guide the illumination beam IL to the TIR prism 80, the TIR prism 80 guides the illumination beam IL to the light valve 90, and the light valve 90 converts the illumination beam IL into the image beam IM. The image beam IM passes through the TIR prism 80 and is transmitted to the projection lens 100.

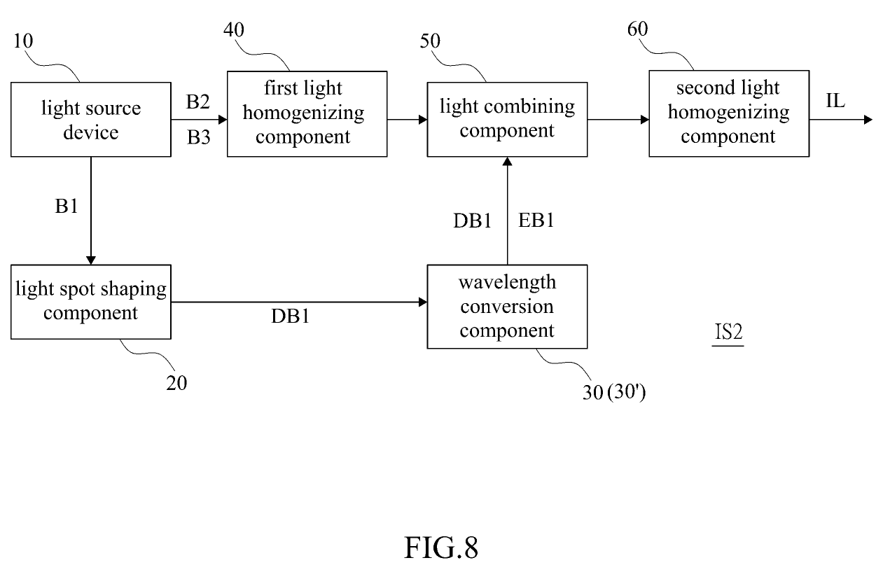

Please refer to FIG. 8, which depicts the block diagram of an illumination system according to another embodiment of the present disclosure. As shown in FIG. 8, the difference between the illumination system IS2 shown in FIG. 8 and the illumination system IS1 shown in FIG. 1: the first color shaping beam DB1 from the wavelength conversion component 30(30’) is directly incident on the light combining component 50, i.e., the first light homogenizing component 40 is not arranged on the travelling path of the first color shaping beam DB1 from the wavelength conversion component 30 and the travelling path of the excited light EB1 from the wavelength conversion component 30. In the present embodiment, the travelling path of the first color shaping beam DB1 is the same as the travelling path of the excited light EB1.

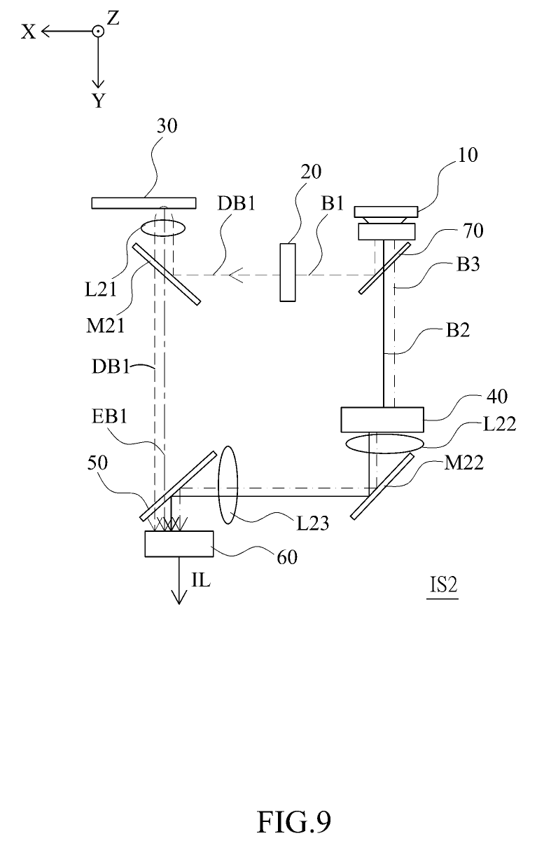

Please refer to FIG. 9, which depicts the configuration diagram of the illumination system according to one embodied aspect of FIG. 8. As shown in FIG. 9, the illumination system IS2 includes the light source device 10, the light spot shaping component 20, the wavelength conversion component 30, the first light homogenizing component 40, the light combining component 50, the second light homogenizing component 60, the dichroic mirror 70, a dichroic mirror M21, a reflective component M22 and lenses L21~L23. The light source device 10, the light spot shaping component 20, the wavelength conversion component 30, the first light homogenizing component 40, the light combining component 50, the second light homogenizing component 60, the dichroic mirror 70, the reflective component M22, and the lenses L22 and L23 shown in FIG. 9 are similar to the light source device 10, the light spot shaping component 20, the wavelength conversion component 30, the first light homogenizing component 40, the light combining component 50, the second light homogenizing component 60, the dichroic mirror 70, the reflective component M4, and the lenses L2 and L3 shown in FIG. 3A and are not repeated.

The first region of the dichroic mirror M21 reflects the first color shaping beam DB1 to the wavelength conversion component 30 (the reflective wavelength conversion component), and the first color shaping beam DB1 is reflected by the non-wavelength-converting region 31, The first color shaping beam DB1 passes through the second region of the dichroic mirror M21, and is transmitted to the light combining component 50. The light combining component 50 allows the first color shaping beam DB1 and at least one part of the excited light EB1 to pass through, reflects the second color beam B2 and the third color beam B3, and is configured to guide at least one part of the excited light EB1, the first color shaping beam DB1, the second color beam B2 and the third color beam B3 to the second light homogenizing component 60. In comparison with the illumination system IS1_D shown in FIG. 3A, the number of the dichroic mirrors used in the illumination system IS2 shown in FIG. 9 is reduced, thereby optimizing the optical path and reducing the needed volume of the illumination system.

Because the travelling path of the first color shaping beam DB1 is the same as the travelling path of the excited light EB1, the working mechanism of the illumination system IS2 shown in FIG. 9 during the different periods is different from the working mechanism of the illumination system IS1_D shown in FIG. 3A during the different periods. The following would elaborate the working mechanism of the illumination system IS2 shown in FIG. 9 during the different periods by the timing diagram of FIG. 4.

As shown in FIG. 3B, FIG. 4A and FIG. 9, during the red beam timing R, the first color light-emitting unit 10B and the third color light-emitting unit 10R are turned on, and the second color light-emitting unit 10G is turned off. The third color beam B3 (the red laser beam) passes through the dichroic mirror 70 and is transmitted to the first light homogenizing component 40. Afterwards, the lens L22, the reflective component M22, and the lens L23 guide the third color beam B3 to the light combining component 50. The light spot shaping component 20 shapes the first color beam B1 to form the first color shaping beam DB1, the wavelength-converting region 32 enters the travelling path of the first color shaping beam DB1, the first region of the dichroic mirror M21 reflects the first color shaping beam DB1 to the wavelength-converting region 32, the wavelength-converting region 32 converts the first color shaping beam DB1 into the excited light EB1, and the excited light EB1 passes through the dichroic mirror M21 and is transmitted to the light combining component 50. Finally, the light combining component 50 guides at least one part of the excited light EB1 and the third color beam B3 to the second light homogenizing component 60, and at least one part of the excited light EB1 and the third color beam B3 which leave from the second light homogenizing component 60 serve as the illumination beam (the red beam).

During the green beam timing G, the third color light-emitting unit 10R is turned off, and the first color light-emitting unit 10B and the second color light-emitting unit 10G are turned on. The second color beam B2 (the green laser beam) passes through the dichroic mirror 70 and is transmitted to the first light homogenizing component 40. Afterwards, the lens L22, the reflective component M22, and the lens L23 guide the second color beam B2 to the light combining component 50. The light spot shaping component 20 shapes the first color beam B1 to form the first color shaping beam DB1, the wavelength-converting region 32 enters the travelling path of the first color shaping beam DB1, the first region of the dichroic mirror M21 reflects the first color shaping beam DB1 to the wavelength-converting region 32, the wavelength-converting region 32 converts the first color shaping beam DB1 into the excited light EB1, and the excited light EB1 passes through the dichroic mirror M21 and is transmitted to the light combining component 50. Finally, the light combining component 50 guides at least one part of the excited light EB1 and the second color beam B2 to the second light homogenizing component 60, and at least one part of the excited light EB1 and the second color beam B2 which leave from the second light homogenizing component 60 serve as the illumination beam (the green beam).

During the blue beam timing B, the second color light-emitting unit 10G and the third color light-emitting unit 10R are turned off, and the first color light-emitting unit 10B is turned on. The light spot shaping component 20 shapes the first color beam B1 to form the first color shaping beam DB1, the non-wavelength-converting region 31 enters the travelling path of the first color shaping beam DB1, and the first region of the dichroic mirror M21 reflects the first color shaping beam DB1 to the non-wavelength-converting region 31, and the first color shaping beam DB1 from the non-wavelength-converting region 31 directly passes through the second region of the dichroic mirror M21 and is incident on the light combining component 50. Finally, the light combining component 50 guides the first color shaping beam DB1 to the second light homogenizing component 60, and the first color shaping beam DB1 which leaves from the second light homogenizing component 60 serves as the illumination beam (the blue beam).

During the yellow beam timing Y, the first color light-emitting unit 10B, the second color light-emitting unit 10G and the third color light-emitting unit 10R are turned on. The third color beam B3 (the red laser beam) and the second color beam B2 (the green laser beam) pass through the dichroic mirror 70 and are transmitted to the first light homogenizing component 40. Afterwards, the lens L22, the reflective component M22 and the lens L23 guide the third color beam B3 and the second color beam B2 to the light combining component 50. The light spot shaping component 20 shapes the first color beam B1 to form the first color shaping beam DB1, the wavelength-converting region 32 enters the travelling path of the first color shaping beam DB1, the first region of the dichroic mirror M1 reflects the first color shaping beam DB1 to the wavelength-converting region 32, the wavelength-converting region 32 converts the first color shaping beam DB1 into the excited light EB1, and the excited light EB1 directly passes through the dichroic mirror M21 and is transmitted to the light combining component 50. Finally, the light combining component 50 guides at least one part of the excited light EB1, the third color beam B3, and the second color beam B2 to the second light homogenizing component 60, and at least one part of the excited light EB1, the third color beam B3, and the second color beam B2 which leave from the second light homogenizing component 60 serve as the illumination beam (the yellow beam ).

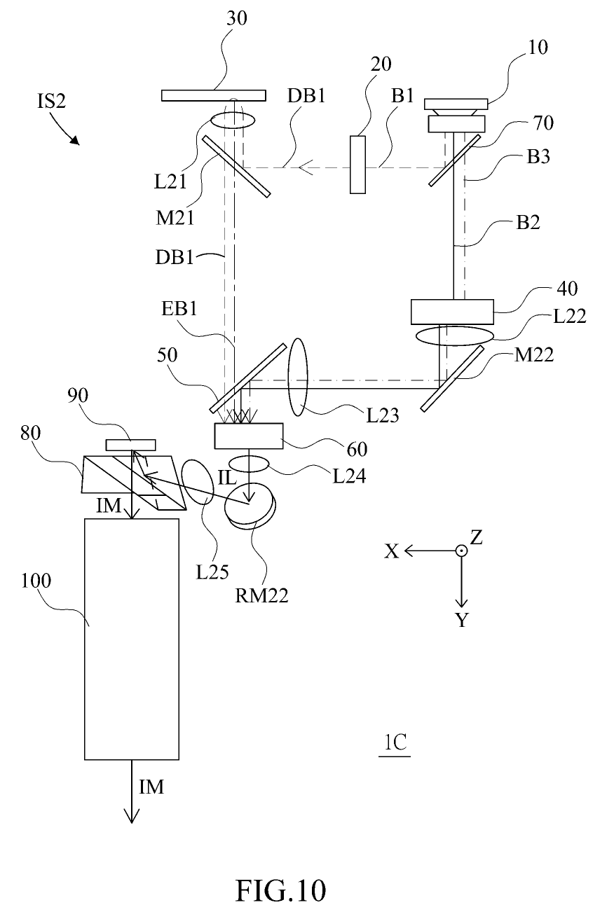

Please refer to FIG. 10, which depicts the configuration diagram of the projection device based on the illumination system shown in FIG. 9. As shown in FIG. 10, the projection device 1C includes the illumination system IS2 of FIG. 9, lenses L24 and L25, a reflector RM22, the TIR prism 80, the light valve 90, and the projection lens 100. The lens L24 and L25, the reflector RM22, the TIR prism 80, the light valve 90, and the projection lens 100 shown in FIG. 10 are similar to the lenses L4 and L5, the reflector RM1, the TIR prism 80, the light valve 90 and the projection lens 100 shown in FIG. 5 and are not repeated.

In addition, the wavelength conversion components in the illumination system shown in FIG. 8, FIG. 9 and FIG. 10 are the transmissive wavelength conversion components. The optical path of the transmissive wavelength conversion component has been explained and is not repeated.

In view of the above description, the illumination system of the present disclosure facilitates the correspondence between the light spot shape of the laser beam and the light spot shape of the excited light by the configurations of the light spot shaping component, the first light homogenizing component and the second light homogenizing component so that the etendue of the laser beam matches the etendue of the excited light, thereby increasing brightness and reducing speckles.

In view of the above description, the projection device of the present disclosure increases the contrast ratio of an image by the configurations of the aforementioned illumination system.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An illumination system, adapted to provide an illumination beam, comprising:
a light source device configured to emit a first color beam and a second color beam;
a light spot shaping component disposed on a travelling path of the first color beam and shaping the first color beam to form a first color shaping beam;
a wavelength conversion component disposed on a travelling path of the first color shaping beam and configured to convert the first color shaping beam into excited light, wherein the excited light and the first color shaping beam leave from the wavelength conversion component at different timing;
a first light homogenizing component disposed on a travelling path of the second color beam; and
a light combining component disposed on a travelling path of the excited light, the travelling path of the first color shaping beam and the travelling path of the second color beam, and guiding at least one part of the excited light, the first color shaping beam and the second color beam to a second light homogenizing component;
wherein the illumination beam comprises at least one of the at least one part of the excited light, the first color shaping beam and the second color beam.

2. The illumination system according to claim 1, wherein the light combining component is disposed between the first light homogenizing component and the second light homogenizing component.

3. The illumination system according to claim 1, wherein the first color shaping beam from the wavelength conversion component passes through the first light homogenizing component and is incident on the light combining component, and the first light homogenizing component is not arranged on the travelling path of the excited light from the wavelength conversion component.

4. The illumination system according to claim 1, wherein the first color shaping beam is directly incident on the light combining component, and the first light homogenizing component is not arranged on the travelling path of the first color shaping beam from the wavelength conversion component and the travelling path of the excited light from the wavelength conversion component.

5. The illumination system according to claim 1, wherein the wavelength conversion component comprises a wavelength-converting region and a non-wavelength-converting region which are disposed on a substrate; the substrate is adapted to rotate around a rotation axis, the wavelength-converting region and the non-wavelength-converting region enter the travelling path of the first color shaping beam at different timing, the wavelength-converting region is configured to convert the first color shaping beam into the excited light, and the non-wavelength-converting region is configured to reflect the first color shaping beam or allow the first color shaping beam to pass through.

6. The illumination system according to claim 1, wherein the light spot shaping component comprises a transparent substrate and a plurality of shaped microstructures disposed on the transparent substrate, the first light homogenizing component comprises a first substrate and a plurality of first microstructures disposed on the first substrate, and the second light homogenizing component comprises a second substrate and a plurality of second microstructures disposed on the second substrate.

7. The illumination system according to claim 6, wherein a shape of orthogonal projection on the transparent substrate of one of the shaped microstructures is different from a shape of orthogonal projection on the first substrate of one of the first microstructures, and a shape of the orthogonal projection on the first substrate of one of the first microstructures is different from a shape of orthogonal projection on the second substrate of one of the second microstructures.

8. The illumination system according to claim 6, wherein each of the first microstructures has a first aspect ratio, each of the second microstructures has a second aspect ratio, and each of the shaped microstructures has a third aspect ratio; the third aspect ratio is different from the first aspect ratio but is similar to or approximates the second aspect ratio.

9. The illumination system according to claim 6, wherein the first light homogenizing component is a fly-eye lens, and the first microstructures is a first microlens array; the second light homogenizing component is the fly-eye lens, and the second microstructures is a second microlens array.

10. The illumination system according to claim 1, wherein the light source device comprises a first color light-emitting unit and a second color light-emitting unit, the first color light-emitting unit is configured to provide the first color beam, and the second color light-emitting unit is configured to provide the second color beam, the first color beam is a blue laser beam, the second color beam is a green laser beam or a red laser beam, and a wavelength range of the excited light at least partially overlaps a wavelength range of the second color beam.

11. The illumination system according to claim 5, wherein the light source device comprises a first color light-emitting unit, a second color light-emitting unit and a third color light-emitting unit, the first color light-emitting unit is configured to provide the first color beam, the second color light-emitting unit is configured to provide the second color beam, and the third color light-emitting unit is configured to provide a third color beam, the first color beam is a blue laser beam, the second color beam is a green laser beam, and the third color beam is a red laser beam, a wavelength range of the excited light at least partially overlaps a wavelength range of the green laser beam, at least, and a wavelength range of the excited light at least partially overlaps a wavelength range of the red laser beam.

12. The illumination system according to claim 11, wherein the first color light-emitting unit and the third color light-emitting unit are turned on and the second color light-emitting unit is turned off during red beam timing, the red laser beam passes through the first light homogenizing component and is incident on the light combining component, the wavelength-converting region enters the travelling path of the first color shaping beam and converts the first color shaping beam into the excited light, and the excited light is transmitted to the light combining component, the light combining component guides the at least one part of the excited light and the red laser beam to the second light homogenizing component, and the at least one part of the excited light and the red laser beam leaving from the second light homogenizing component serve as the illumination beam.

13. The illumination system according to claim 11, wherein the third color light-emitting unit is turned off and the first color light-emitting unit and the second color light-emitting unit are turned on during green beam timing, the green laser beam passes through the first light homogenizing component and is incident on the light combining component, the wavelength-converting region enters the travelling path of the first color shaping beam and converts the first color shaping beam into the excited light, and the excited light is transmitted to the light combining component, the light combining component guides the at least one part of the excited light and the green laser beam to the second light homogenizing component, and the at least one part of the excited light and the green laser beam leaving from the second light homogenizing component serve as the illumination beam.

14. The illumination system according to claim 11, wherein the second color light-emitting unit and the third color light-emitting unit are turned off and the first color light-emitting unit is turned on during blue beam timing, the non-wavelength-converting region enters the travelling path of the first color shaping beam, the first color shaping beam from the non-wavelength-converting region is incident on the light combining component after passing through the first light homogenizing component or is directly incident on the light combining component, the light combining component guides the first color shaping beam to the second light homogenizing component, and the first color shaping beam leaving from the second light homogenizing component serves as the illumination beam.

15. The illumination system according to claim 11, wherein the first color light-emitting unit, the second color light-emitting unit and the third color light-emitting unit are turned on during yellow beam timing, the red laser beam and the green laser beam pass through the first light homogenizing component and are incident on the light combining component, the wavelength-converting region enters the travelling path of the first color shaping beam and converts the first color shaping beam into the excited light, and the excited light is transmitted to the light combining component, the light combining component guides the at least one part of the excited light, the red laser beam and the green laser beam to the second light homogenizing component, and the at least one part of the excited light, the red laser beam and the green laser beam leaving from the second light homogenizing component serve as the illumination beam.

16. The illumination system according to claim 1, further comprising a dichroic mirror located between the light source device and the first light homogenizing component, the light spot shaping component is located between the dichroic mirror and the wavelength conversion component, and the dichroic mirror guides the second color beam to the first light homogenizing component and guides the first color beam to the light spot shaping component.

17. The illumination system according to claim 11, further comprising a polarization component disposed between the light source device and the first light homogenizing component;
the polarization component is arranged on a travelling path of the red laser beam and is configured to change a polarization state of the red laser beam so that the polarization state of the red laser beam is the same as a polarization state of the blue laser beam and a polarization state of the green laser beam; or
the polarization component is arranged on a travelling path of the blue laser beam and a travelling path of the green laser beam and is configured to change the polarization state of the blue laser beam and the polarization state of the green laser beam so that the polarization state of the blue laser beam and the polarization state of the green laser beam are the same as the polarization state of the red laser beam.

18. The illumination system according to claim 1, wherein the light spot shaping component is an anisotropic diffuser, a lens array component or a cylindrical lens array component.

19. A projection device comprising an illumination system according to claim 1, a light valve and a projection lens, wherein the light valve is disposed on a travelling path of the illumination beam and converts the illumination beam into an image beam, and the projection lens is disposed on a travelling path of the image beam.

20. The projection device according to claim 19, wherein the light spot shaping component is provided with a plurality of shaped microstructures, the first light homogenizing component is provided with a plurality of first microstructures, the second light homogenizing component is provided with a plurality of second microstructures, and the light valve is provided with a plurality of micromirrors.

21. The projection device according to claim 20, wherein each of the first microstructures has a first aspect ratio, each of the second microstructures has a second aspect ratio, each of the shaped microstructures has a third aspect ratio, and each of the micromirrors has a micromirror aspect ratio; the third aspect ratio is different from the first aspect ratio but is similar to or approximates the second aspect ratio and the micromirror aspect ratio.
